(19) United States
(12) Patent Application Publication
(10) Pub. No.: US 2007/0163370 A1
(43) Pub. Date: Jul. 19, 2007

(54) Wobble drive

(75) Inventors: Rudolf Berger, Grunwald (DE); Wolfgang Schmid, Munchen (DE); Otto W. Stenzel, Neuhutten/Wustenrot (DE); Michael Fischer, Munchen (DE)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: WACKER CONSTRUCTION EQUIPMENT AG, Munchen (DE)

(21) Appl. No.: 10/598,456

(22) PCT Filed: Mar. 11, 2005
(86) PCT No.: PCT/EP05/02620

§ 371 Date: Aug. 31, 2006

(30) Foreign Application Priority Data
Mar. 16, 2004 (DE) 10 2004 012 820.0

(51) Int. Cl. F16H 23/00

(52) U.S. Cl. 74/60

(57) ABSTRACT

The invention relates to a wobble drive, in which a shaft supports a wobble ring by means of a pivot bearing, a finger extending from said ring. To reduce vibrations caused by the movement of the finger, at least one balancing mass is configured on the shaft. Alternatively or in addition, at least one balancing mass can be provided on the wobble ring. This allows the vibrations that are caused naturally by the movement of the finger to be compensated.

### BACKGROUND OF THE INVENTION

1. Field of the Invention

The present invention relates to a wobble drive according to the preambles of patent claims 1 and 10.

2. Description of the Related Art

The designation “wobble drive” refers to a device for converting a rotational motion into an oscillating translational motion. Here, a rotationally driven rotating element acts on a wobble element in such a way that the wobble element is driven so as to tilt back and forth, so that it can set another element into linear translational motion.

Such a wobble drive is known for example from DE 198 51 888 C1. As is also described in DE 198 51 888 C1, wobble drives are used for example in drilling or percussion hammers to convert the rotational motion of a drive into an oscillating translational motion that can be used in a percussion mechanism to apply impacts to a tool.

FIG. 1 shows an example of a known wobble drive for such a pneumatic spring hammer mechanism.

A shaft 1 that acts as a drive shaft is driven in rotational fashion by a drive (not shown), e.g. an electric motor, via a toothed wheel 2. Shaft 1 is mounted so as to be capable of rotation at bearing points 3 and 4 (shown schematically). These bearing points 3, 4 are standardly roller bearings that are supported in a housing (not shown), as is also indicated in DE 198 51 888 C1.

On shaft 1, a pivot bearing 5 is fastened to an inner ring 5a. Inner ring 5a must be fastened in rotationally fixed fashion to shaft 1, e.g. via a press fit. If necessary, shaft 1 and inner ring 5a can also be manufactured in one piece.

Inner ring 5a has an annular inner running surface 6 that is situated in a plane that does not stand perpendicular to an axis of rotation 7 of shaft 1. In the example in FIG. 1, the angle α between the plane of the inner running surface and the plane perpendicular to axis of rotation 7 is approximately 30°.

A wobble ring 8 is situated around inner ring 5a and has on its inner side an outer running surface 9 that is allocated to inner running surface 6. Between inner running surface 6 and outer running surface 9, roller bearings 10 are situated in movable fashion in a known manner. Inner ring 5a with inner running surface 6, wobble ring 8 with outer running surface 9, and roller elements 10 together effectively form pivot bearing 5, realized in the depicted example as a roller bearing. Alternatively, other types of bearings, such as for example plain bearings, can be used.

On the outside of wobble ring 8, a wobble finger 12 extends from a linkage point 11, radially to a center axis 13 of wobble ring 8.

An end of wobble finger 12 facing away from wobble ring 8 passes through a piston bolt 14, which in turn is fastened to a drive piston 15 of a pneumatic spring hammer mechanism.

In FIG. 1, in drive piston 15 an impact piston 16 that belongs to the pneumatic spring hammer mechanism is shown. Such pneumatic spring hammer mechanisms are known. However, because they do not relate to the subject matter of the present invention, they are not explained in more detail here.

During operation of the wobble drive, shaft 1 is rotated together with inner ring 5a. Due to the obliquely situated inner running surface 6, roller elements 10 running around it, and with them wobble ring 8, are set into a wobbling motion that can be converted into a linear back-and-forth motion through the guiding of piston bolt 14 and drive piston 15.

Wobble finger 12 represents a significant imbalance mass that, at faster speeds of motion (several hundred impacts per minute) results in significant additional oscillating bearing loads that act both on the machine (bearing, housing) and on the operator holding the machine.

Because such wobble drives are often used in hammers, this means that the operator is exposed not only to an impact loading due to the impacts executed by the hammer, but also to the imbalance loading resulting from the moving wobble finger.

### OBJECT AND SUMMARY OF THE INVENTION

The object of the present invention is to reduce the imbalance forces produced by the motion of the wobble finger in a wobble drive, and thus to prevent vibrational disturbance of the wobble drive.

According to the present invention, this object is achieved by a wobble drive as recited in patent claims 1 and 10. Advantageous further developments of the present invention are defined in the dependent claims.

In a first solution according to the present invention, at least one balance mass is fashioned on the shaft. The balance mass is to be provided in addition to the pivot bearing held by the shaft and to an imbalance resulting from the asymmetrical design of this bearing.

Due to the additional constructively provided balance mass, on the shaft an imbalance force is produced that, given corresponding dimensioning and design, can be superposed on the imbalance force produced by the motion of the wobble finger in such a way that the imbalance forces cancel each other out at least partially, or in any case are reduced in the resultant forces.

In a preferred specific embodiment of the present invention, the pivot bearing has an inner ring, formed on the shaft, to which a wobble ring is allocated. Between the inner ring and the wobble ring, roller elements belonging to the pivot bearing can circulate.

The balance mass can be produced by adding mass elements to the shaft. Alternatively, it is also possible to create a corresponding balance mass by removing material at another place on the shaft.

In a particularly advantageous specific embodiment of the present invention, the shaft is mounted at two bearing points, a balance mass being allocated to each of the bearing points. Here, the term “balance mass” is to be understood abstractly. Of course, an imbalance mass can also be formed by a plurality of individual mass elements that are to be situated relative to one another in a manner suitable for producing a corresponding overall mass effect.

Thus, each balance mass, at its allocated bearing point, is able to produce in a targeted manner a counterforce that is superposed on the action of the wobble finger, in order in this way to reduce the resulting bearing force.

In a particularly advantageous construction of the present invention, the axial distance between a bearing point and the balance mass allocated thereto is minimal. In this way, the action of the balance mass can be transmitted particularly well to the bearing point allocated thereto.

In another advantageous construction, the balance masses allocated to the two bearing points are situated opposite one another, relative to the axis of rotation of the shaft. This means that the centrifugal forces produced by the balance masses are displaced by 180° relative to one another.

In addition, the two balance masses produce around the center of the shaft a torque that counteracts the wobble moment produced by the wobble finger.

It is particularly advantageous if the wobble ring is essentially rotationally symmetrical, with the exception of the area from which the wobble finger extends radially. The wobble ring should have as low a weight as possible, in order to prevent additional wobble moments from arising.

In another solution of the object of the present invention, defined in claim 10, on the wobble ring at least one balance mass is provided in an area that is situated neither at the linkage point nor (in relation to the center axis of the wobble ring) opposite the linkage point at which the wobble finger extends radially from the wobble ring.

Surprisingly, it has turned out that the attaching of balance masses that are situated laterally to the wobble finger in relation to the wobble ring produces an imbalance force that counteracts the wobble moment of the wobble finger and thus results in a reduction of the vibrational forces. In this variant as well, the pivot bearing standing obliquely between the shaft and the wobble ring can be realized by various bearing types; the roller bearing is to be preferred due to its lower friction and high resistance to wear.

It is particularly advantageous if two balance masses are provided that are situated opposite one another on the wobble ring, in relation to the center axis of the wobble ring. Here, the balance masses should be situated with the same angular distance relative to the linkage point of the wobble finger, preferably 90° in relation to the center axis of the wobble ring.

In addition, it is advantageous if the wobble ring, with the exception of the linkage point from which the wobble finger extends, and the areas in which the additional balance masses are provided, are essentially rotationally symmetrical. This is because it has turned out that the situation of balance masses in areas other than those defined above does not result in an improvement of the vibrational situation, but rather in an amplification of the imbalance forces and thus of the vibrations.

In a particularly advantageous specific embodiment of the present invention, the two solutions of the object of the invention described separately above are combined with one another. This means that the wobble drive has on the one hand a shaft on which additional balance masses are attached, and on the other hand balance masses are also provided on the wobble ring in the manner described above. The combination of the balance masses and the overall forces and moments resulting therefrom effects a significant reduction of the undesired vibrations.

These and other advantages and features of the present invention are explained in more detail below with the assistance of the accompanying Figures.

### BRIEF DESCRIPTION OF THE DRAWINGS

FIG. 1 shows a schematic section through a wobble drive, known from the prior art, for a pneumatic spring hammer mechanism;

FIG. 2 shows a diagram with the bearing forces that are to be expected in a wobble drive that is not designed according to the present invention;

FIG. 3 schematically shows a wobble drive according to the present invention;

FIG. 4 shows a diagram illustrating the reduction of the overall bearing loads resulting from balance masses on the shaft (first specific embodiment of the present invention);

FIG. 5 shows a diagram illustrating the bearing loads given imbalances on the shaft and on the wobble ring (third specific embodiment of the present invention).

### DETAILED DESCRIPTION OF THE PREFERRED EMBODIMENTS

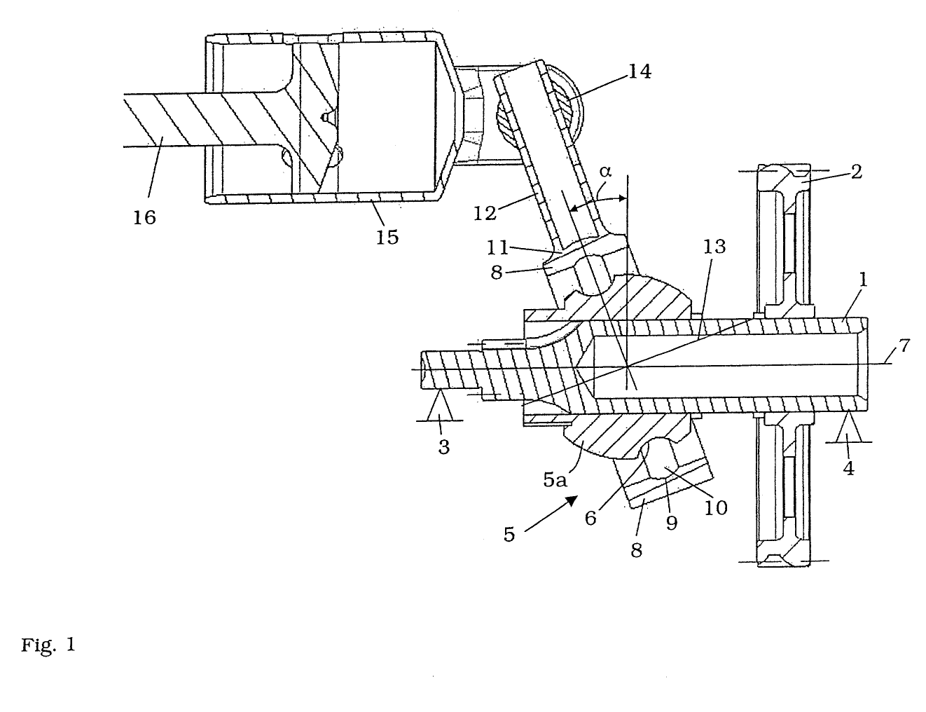

The design of a wobble drive is known, and has already been explained above with reference to FIG. 1. In order to avoid repetition, reference is made here to that description.

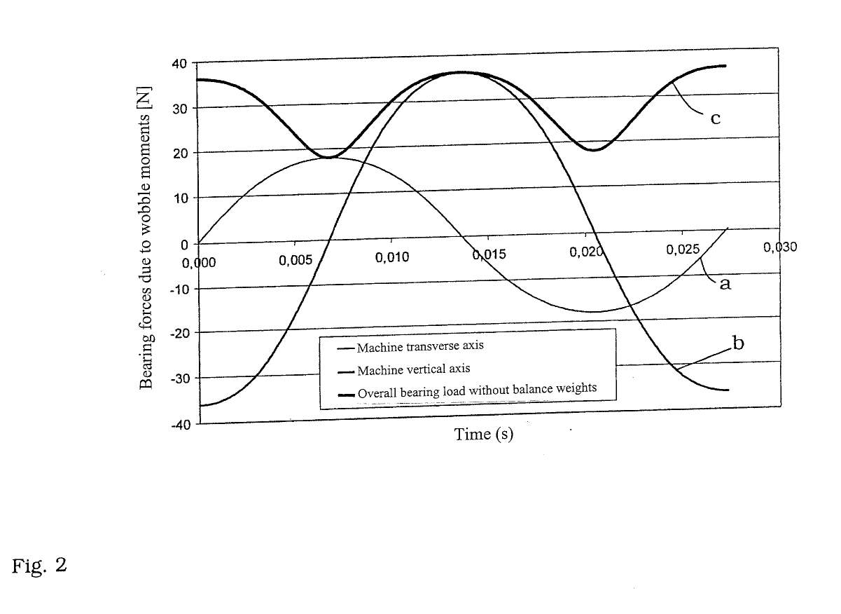

In the wobble drive as shown in FIG. 1, at bearing points 3, 4 bearing loads occur that in FIG. 2 are plotted over time in relation to an example. Curve a here represents the bearing forces in the direction of a transverse axis (horizontal plane), and curve b corresponds to the bearing load in the direction of the vertical axis of the machine. Here it is assumed that wobble finger 12 is oriented essentially vertically, i.e., in the direction of the machine's vertical axis.

Superposition of curves a and b yields the overall bearing load according to curve c.

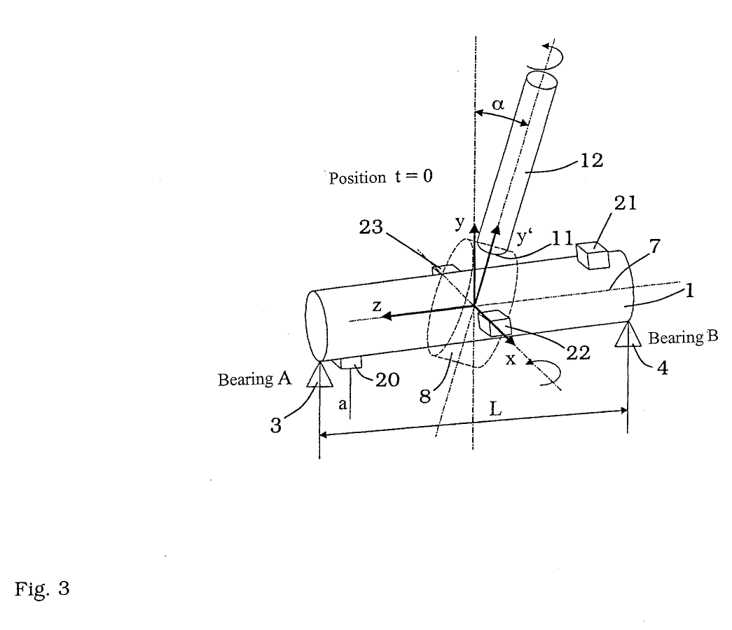

The wobble drive according to the present invention is now explained on the basis of the schematic representation shown in FIG. 3.

FIG. 3 makes use of the essential components seen in FIG. 1, namely shaft 1, wobble ring 8, and wobble finger 12. In addition, bearing points 3 and 4 are symbolically shown. For the rest, the detailed technical realization can take place essentially according to FIG. 1.

In a first specific embodiment of the present invention, balance masses 20 and 21 are provided on shaft 1, balance mass 20 being situated as close as possible (with respect to axial distance a) to bearing point 3, and balance mass 21 being situated as close as possible to bearing point 4. In addition, in FIG. 3 it can be seen that balance masses 20 and 21 are situated opposite one another relative to axis of rotation 7 of the shaft. In this way, balance masses 20 and 21 produce a torque about axis X that is directed opposite the wobble moment of wobble finger 12.

The dimensions of balance masses 20, 21, in particular their mass and their distance from axis of rotation 7, can easily be determined by someone skilled in the art through trials.

Distance a of balance mass 20 from bearing point 3, and, correspondingly, the distance from balance mass 21 to bearing point 4, should be as small as possible in order to deploy a maximum effect of balance masses 20, 21. This results from the fact that the closer balance masses 20, 21 are situated to bearing points 3, 4, the greater the moment about the X axis becomes.

As shown in FIG. 3, balance masses 20, 21 can be formed by attaching additional mass elements. Alternatively, material can also be removed from shaft 1 at the respectively opposite side of the shaft in order to produce the desired balance. Here, “balance” generally designates the product of a balance mass and the distance of its center of mass from axis of rotation 7.

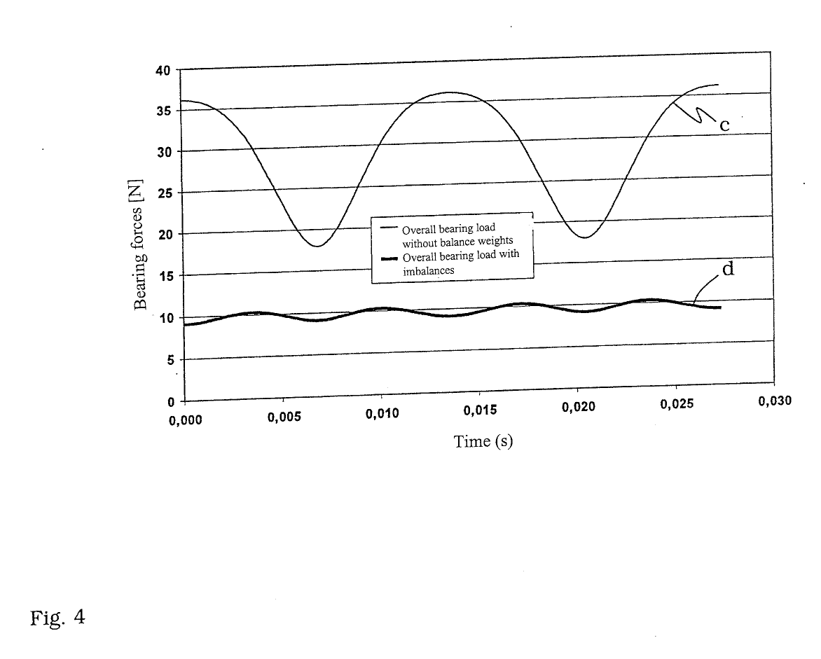

Given suitable dimensioning and situation of balance masses 20, 21, the overall bearing load c shown in FIG. 2 can be reduced. In FIG. 4, the curve c is taken from FIG. 2. The curve d represents the curve of the overall bearing load when balance masses 20, 21 are provided on shaft 1. The significant reduction in overall bearing load resulting therefrom is clearly visible in FIG. 4.

In a second specific embodiment of the present invention, additional balance masses 22 and 23 are attached to wobble ring 8 (FIG. 3). However, in the second specific embodiment of the present invention, no balance masses 20, 21 are fashioned on shaft 1, in contrast to the representation shown in FIG. 3.

Balance masses 22, 23 are situated opposite one another in an area that is displaced by 90° in relation to linkage point 11 of wobble finger 12.

Balance masses 22, 23 result in a matching of the maximum bearing forces in the vertical (Y) and transverse (X) directions of the machine, whereby the effective bearing forces can be made uniform. As was shown in FIG. 2, the bearing forces acting in the machine's vertical axis (curve b) are greater than the forces in the machine's transverse axis (curve a).

Thus, the attaching of balance masses 22, 23 already achieves a reduction in the undesired vibrational forces.

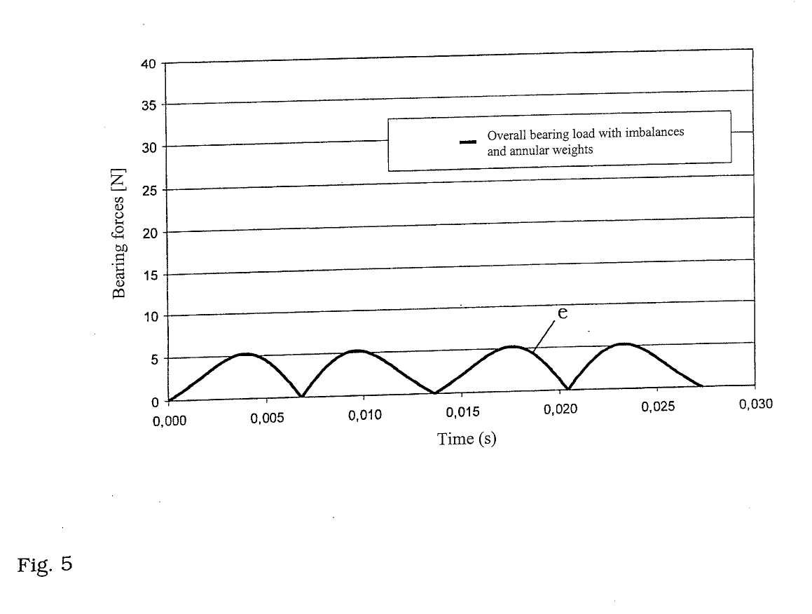

In a third specific embodiment of the present invention, shown in FIG. 3, the teachings of the first and second specific embodiment described above are combined. This means that first, through balance masses 22, 23 on wobble ring 8, the maximum bearing forces acting in the X- and Y-direction can be matched to one another. These forces are then largely compensated by balance masses 20, 21 on shaft 1. Ultimately, a bearing force curve such as that shown as curve e in FIG. 5 can be expected.

If curve e in FIG. 5 is compared with curve c in FIG. 2, it can be clearly seen that the large vibrational forces that exist in the absence of additional balance masses 20, 21, 22, 23 can be largely canceled.

Considered in themselves, the first and the second specific embodiments already achieve a significant improvement in the reduction of undesired vibrational forces. The combination of the first and the second specific embodiments, resulting in the third specific embodiment, permits an even greater reduction in vibration.

1. A wobble drive, comprising
a shaft;
a pivot bearing that is situated on the shaft and that is inclined in relation to an axis of rotation of the shaft;
a wobble finger that extends away from the axis of rotation of the shaft and is held by the pivot bearing;
wherein at least one balance mass is fashioned on the shaft.

2. The wobble finger drive as recited in claim 1, wherein the balance mass is situated on the shaft in such a way that it counteracts the imbalance resulting from the design of the wobble drive.

3. The wobble drive as recited in claim 1, wherein
the pivot bearing has an inner ring fashioned on the shaft having an annular inner running surface for roller elements, the inner running surface being situated in a plane that does not stand perpendicular to the axis of rotation of the shaft;
a wobble ring, situated around the inner ring, is allocated to the pivot bearing, said wobble ring having an outer running surface for the roller elements that is allocated to the inner running surface; and in that
the wobble finger extends from the wobble ring radially to a center axis of the wobble ring.

4. The wobble drive as recited in claim 1, wherein the balance mass is capable of being manufactured by removing material from the shaft.

5. The wobble drive as recited in claim 1, wherein
the shaft is mounted at at least two bearing points;
a balance mass is allocated to at least one of the bearing points.

6. The wobble drive as recited in claim 5, wherein
the shaft is mounted at two bearing points; and wherein
a balance mass is allocated to each of the bearing points.

7. The wobble drive as recited in claim 6, wherein the axial distance (a) between a bearing point (3) and the balance mass (20) allocated thereto is minimal.

8. The wobble drive as recited in claim 6, wherein the balance masses allocated to the two bearing points (3, 4) are situated opposite one another in relation to the axis of rotation (7) of the shaft (1).

9. The wobble drive as recited in claims 1, wherein the wobble ring is essentially rotationally symmetrical, with the exception of the area from which the wobble finger extends.

10. A wobble drive, comprising
a shaft;
a pivot bearing that is situated on the shaft and that is inclined in relation to an axis of rotation of the shaft;
a wobble ring held by the pivot bearing;
a wobble finger that, at a linkage point, extends from the wobble ring radially to a center axis of the wobble ring;
wherein, on the wobble ring, at least one balance mass is provided in an area that is situated neither at the linkage point nor opposite the linkage point, in relation to the center axis of the wobble ring.

11. The wobble drive as recited in claim 10, wherein
the pivot bearing has an inner ring fashioned on the shaft, having an annular inner running surface for roller elements, the inner running surface being situated in a plane that does not stand perpendicular to the axis of rotation of the shaft; and wherein
the wobble ring is allocated to the inner ring, and has an annular outer running surface, allocated to the inner running surface, for the roller elements.

12. The wobble drive as recited in claim 10, wherein two balance masses are provided that are situated opposite one another on the wobble ring, in relation to the center axis of the wobble ring.

13. The wobble drive as recited in claim 10, wherein two balance masses are provided, and wherein the linkage point stands at the same angular distance to the two balance masses, in relation to the center axis of the wobble ring.

14. The wobble drive as recited in claim 10, wherein
the one balance mass is situated in an area of the wobble ring that is offset by +90° relative to the linkage point of the wobble finger, in relation to the center axis of the wobble ring, and wherein
the other balance mass is situated in an area of the wobble ring that is offset by −90° relative to the linkage point of the wobble finger, in relation to the center axis of the wobble ring.

15. The wobble drive as recited in claim 10, wherein the wobble ring is essentially rotationally symmetrical, with the exception of the linkage point from which the wobble finger extends and the areas in which the balance masses are provided.

16. The wobble drive as recited in claim 10, wherein the balance mass is capable of being manufactured by removing material from the wobble ring.

17. A wobble drive, comprising:
a shaft;
a pivot bearing that is situated on the shaft and is inclined in relation to an axis of rotation of the shaft;
a wobble finger that, at a linkage point, extends from the wobble ring radially to a center axis of the wobble ring, that extends away from the axis of rotation of the shaft, and that is held by the pivot bearing;
wherein at least one balance mass is fashioned on the shaft, and
wherein at least one additional balance mass is provided on the wobble ring in an area that is situated neither at the linkage point nor opposite the linkage point, in relation to the center axis of the wobble ring.

18. The wobble drive as recited in claim 1, wherein a balance mass is formed from a plurality of balance mass elements.
